(19) United States
(12) Patent Application Publication
(10) Pub. No.: US 2008/0228387 A1
(43) Pub. Date: Sep. 18, 2008

(54) REGIONAL MESSAGE REMINDER APPARATUS AND METHOD, AND INTEGRATION MESSAGE REMINDER APPARATUS AND METHOD

(75) Inventor: Wei-Tsu Yang, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: MITAC INTERNATIONAL CORP., TAOYUAN (TW)

(21) Appl. No.: 12/047,564

(22) Filed: Mar. 13, 2008

(30) Foreign Application Priority Data
Mar. 14, 2007 (TW) 096108786

(51) Int. Cl. G01C 21/34; G01S 1/00; G06F 7/06; G06F 17/30

(52) U.S. Cl. 701/201; 342/357.06; 707/5; 707/E17.018; 707/E17.017

(57) ABSTRACT

A regional message reminder apparatus comprises a satellite positioning device, a database, a user interface module and a processing module. The satellite positioning device is used for providing user position data. The user interface module is used for allowing a user to input at least one address data and at least one reminder message corresponding to the address data. The database is used for storing said address data and said reminder message. The processing module then compares the address data with the user position data. When the address data and the user position data are within a predetermined distance apart, the processing module drives the user interface module to display the reminder message corresponding to the first address data.

### BACKGROUND OF THE INVENTION

1. Field of the Invention

The present invention relates to regional message reminder apparatus and method and integration message reminder apparatus and method, and more particularly to the regional message reminder apparatus that provides user position data to users through satellite positioning devices and integrates a regional message reminder system and a calendar system.

2. Description of the Related Art

As handheld devices become increasingly popular and users get used to plan their schedules by calendar software, particularly for the function of a work reminder, so that users will not miss important apportionments or works. However, the calendar software is mainly derived from personal computer applications, and thus its original design has not taken mobility into consideration, but time is a primarily as the basis for planning their work only. However, such function no longer satisfies the requirements of the present handheld devices, and a message reminder based on position catches users' attentions now. At present, only navigation systems adopt position as the basis for setting a message reminder to remind users about their over-speed driving, but this function is applied in the navigation systems only, and unable to let users input a desired position and the content of the message reminder. Obviously, the conventional design does not meet the requirements of users' daily life.

To achieve the foregoing objectives and overcome the shortcomings of the prior art, the inventor of the present invention based on years of experience in the related industry to conduct extensive researches and experiments, and finally developed regional message reminder apparatus and method and integration message reminder apparatus and method in accordance with the present invention.

### SUMMARY OF THE INVENTION

The primary objective of the present invention is to provide a regional message reminder apparatus and method and integration message reminder apparatus and method, wherein the regional message reminder apparatus provides user position data through a satellite positioning device and displays the corresponding reminder message when users approach a specific position. Further, the integration message reminder apparatus integrates a regional message reminder system and a calendar system into an apparatus having the functions of a regional message reminder and a time message reminder.

To achieve the foregoing objective, the present invention provides a regional message reminder apparatus comprising a satellite positioning device, a database, a user interface module and a processing module, and the satellite positioning device is used for providing user position data, and the database is used for storing a plurality of address data, and a plurality of reminder messages corresponding to the address data, and the user interface module is provided for users to input and display the address data and the reminder message, and the processing module compares the user position data with the address data, such that if a first address data in the address data and the user position data are within a predetermined distance, the reminder message corresponding to the first address data will be displayed through the user interface module.

Since the regional message reminder apparatus and method and the integration message reminder apparatus and method set the message reminders based on position and time, the satellite positioning device detects a user's position to automatically display a pre-inputted reminder message to remind the user about a work related to the specific position or life information when the user is approaching the pre-inputted position. The apparatus also integrates a message reminder based on time and provides a combination of applications for users. For instance, users have to pass a certain specific position with a specific time before the message reminder appears, and thus the present invention can provide users more diversified and convenient reminder functions.

To make it easier for our examiner to understand the technical characteristics and performance of the present invention, we use preferred embodiments with the attached drawings for the detailed description of the invention.

### BRIEF DESCRIPTION OF THE DRAWINGS

FIG. 1 is a block diagram of a regional message reminder apparatus of the present invention;

FIG. 2 is a schematic view of a regional message reminder apparatus of a preferred embodiment of the present invention;

FIG. 3 is a flow chart of a regional message reminder method of the present invention;

FIG. 4 is a block diagram of an integration message reminder apparatus of the present invention;

FIG. 5 is a schematic view of an integration message reminder apparatus of a preferred embodiment of the present invention; and

FIG. 6 is a flow chart of an integration message reminder method of the present invention.

### DETAILED DESCRIPTION OF THE PREFERRED EMBODIMENTS

For simplicity, like numerals are used for like elements for the description of the specification of the present invention as follows.

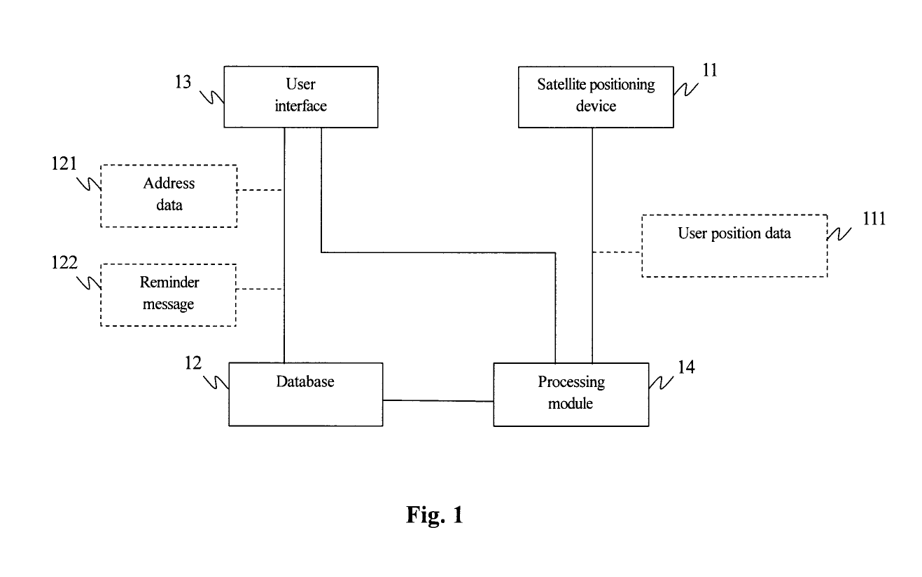

Referring to FIG. 1 for a block diagram of a regional message reminder apparatus of the present invention, the apparatus includes a satellite positioning device 11, a database 12, a user interface module 13 and a processing module 14. The satellite positioning device 11 is used for providing user position data 111, such as the current coordinate of the user's location. The satellite positioning device 11 can receive satellite signals from plurality of GPS satellite and calculate the current coordinate based on the satellite signals. The user interface module 13 is provided for allowing a user to input at least one address data 121, and the reminder message 122 corresponding to the address data 121. Preferably, the user interface module 13 can includes a touch screen or a speech input interface unit. Generally, the address data 121 can be the address of specific store where the user plans to visit or the user has something to do therein, and the reminder message can be description of the plan or the to-do item. The address data 121 and the reminder message 122 are stored in the database 12.

The processing module 14 is operable to compare the user position data 111 with the address data 121, if the address data 121 and the user position data 111 are within a predetermined distance, it means that the user is near the location with the address data 121, then the processing module 14 drives the user interface module 13 to display reminder message 122 corresponding to the address data 121 for notifying the user.

If the user inputs a plurality of address data 121, the processing module 14 will compare each address data 121 with the user position data 111 and select the address data which is apart from the user position data 111 within the predetermined distance, and the reminder message 122 corresponding to the selected address data 121 will be displayed on the user interface module 13. Preferably, the processing module 14 compares the address data with the user position data by calculating the distance between the user's position and the location with the address data. The user can set the predetermined distance based on his/her habit.

In this embodiment, the reminder message 122 includes a text reminder message. If necessary, the reminder message 122 can further includes a voice reminder message, and the regional message reminder apparatus further comprises an amplifier for sending out the voice reminder message.

After reading or listening the reminder message 122 corresponding to the location with address data 121 which is reminded to the user, the user can choose to go to the location directly and operate the regional message reminder apparatus to set such location as a destination and calculate a route from the current position to such location.

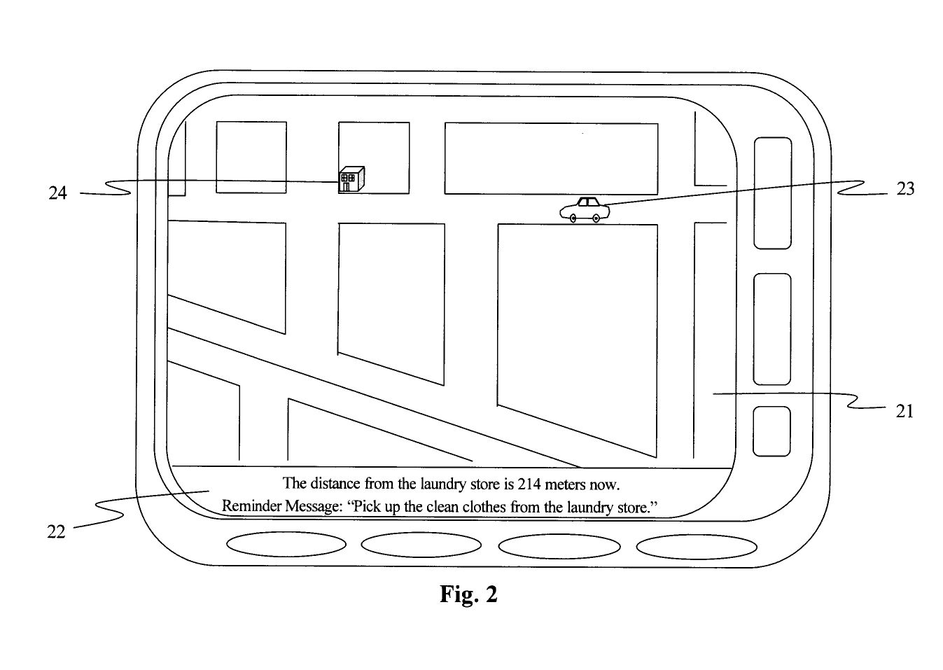

Referring to FIG. 2 for a schematic view of a regional message reminder apparatus of a preferred embodiment of the present invention, a map of a vehicle driving path is displayed through a map window 21 while a user is driving a vehicle 23, and the user can input a plurality of address data and a reminder message corresponding to the address data in advance. For instance, the user can input an address data of a laundry store 24, and a corresponding reminder message shows “Pick up the clean clothes from the laundry store”.

While the user is driving the vehicle 23 to work, from work or go out, and the vehicle 23 is approaching the laundry store 24 within a predetermined distance, a reminder message will appear on the message window 22 automatically to remind the user to go to the laundry store 24 to pick up the clean clothes, and thus the user can pick up the cloth on the way, and needs not to make a special trip. Preferably, after reading or listening the reminder message, if the user has no idea about how to reach the laundry store 24 from the current position, the user can select the laundry store 24 as a destination and start navigation. For example, the use can double-click the icon of the laundry store 24 displayed on the map window 21 for triggering the regional message reminder apparatus to calculate a route from the current position to the laundry store 24 and then navigate the user to the laundry store 24.

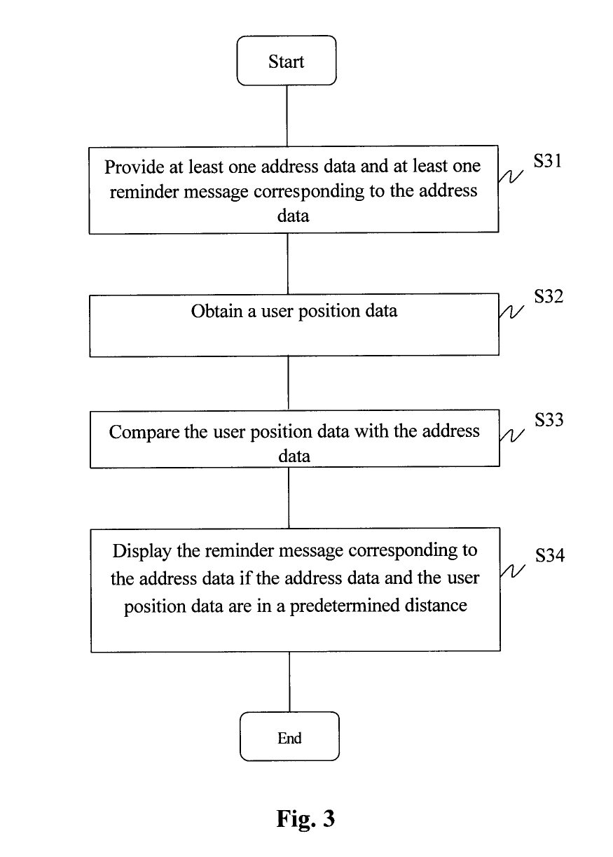

FIG. 3 illustrates a flow chart of a regional message reminder method in accordance with the present invention. In one embodiment, the user can operate a regional message reminder apparatus shown in FIG. 2 according to this regional message reminder method. This method comprises the following steps. In step S31 at least one address data and at least one reminder message corresponding to the address data are provided. For example, user can operate the user interface module 13 to input the address data and reminder message. Preferably, the user interface module 13 can include a touch screen or a speech input interface unit, so the user can input the address data and reminder message by keying or speaking.

In step S32 the user position data is obtained. For example, user can obtain the current coordinate of his/her location from the satellite positioning device 11. Then in the step S33 the user position data is compared with the address data for determining whether there is any inputted address data near the user. For example, the processing module 14 is operable to perform such comparison. In step S34 the reminder message corresponding to the address data is displayed if the address data and the user position data are within a predetermined distance. For example, the user is reminded by the reminder message 122 corresponding to the address data 121 when user is near the location with the address data 121.

Preferably, the reminder message includes a text reminder message, and if necessary, the reminder message can further includes a voice reminder message, and the regional message reminder method further comprises a step of sending out the voice reminder message.

Preferably, after reading or listening the reminder message, the user can choose to go to the location with the reminded address data directly and select such location as a destination, and a route from the current position to such location is calculated and the user can be navigated based on the route.

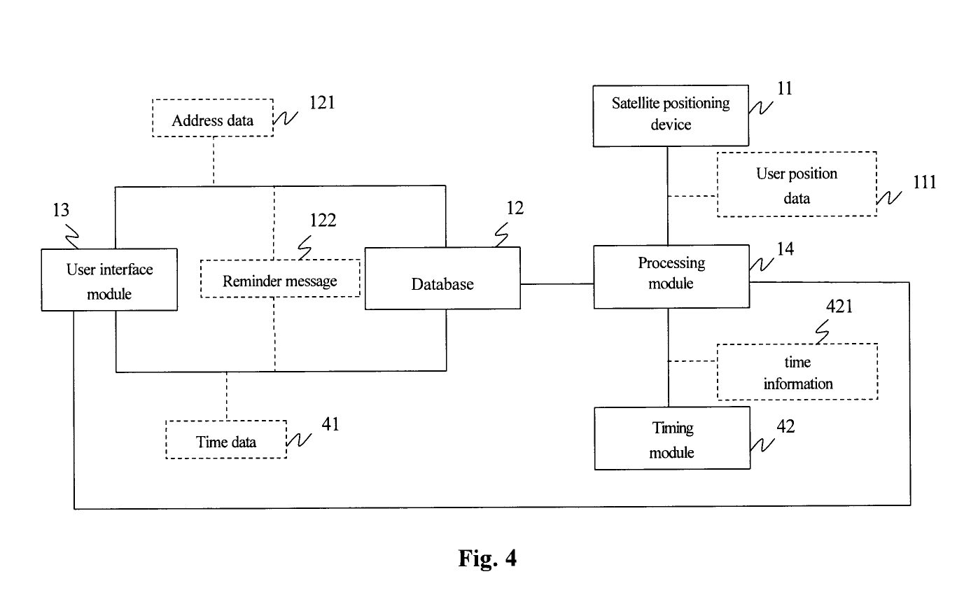

Referring to FIG. 4 for a block diagram of an integration message reminder apparatus of the present invention, the integration message reminder apparatus comprises a satellite positioning device 11, a database 12, a user interface module 13, a timing module 42 and a processing module 14. The satellite positioning device 11 is used for providing user position data 111. The user interface module 13 is provided for allowing a user to input at least one address data 121, at least one time data 41 and the reminder message 122 corresponding to the address data 121 and the time data 41. The database 12 is used for storing the address data 121, the time data 41, and the reminder message 122. The timing module 42 is used for computing time information 421. For example, the time information 421 can be obtained from the received satellite signals. Preferably, the time data 41 contains a specific date, a specific hour and a specific minute, and the time information 421 contains a current date, a current hour and a current minute.

The processing module 14 compares the user position data 111 with the address data 121, and compares the time information 421 with the time data 41, such that if the address data 121 and the user position data 111 are within a predetermined distance or the difference between the time data 41 and the time information 421 is smaller than a predetermined time interval, the reminder message 122 corresponding to the address data will be displayed on the user interface module 13 or the reminder message 122 corresponding to the time data 41 will be displayed on the user interface module 13.

Preferably, the reminder message 122 includes a text reminder message. If necessary, the reminder message 122 can further includes a voice reminder message, and the regional message reminder apparatus further comprises an amplifier for sending out the voice reminder message. The user interface module 13 can include preferably a touch screen or a speech input interface unit.

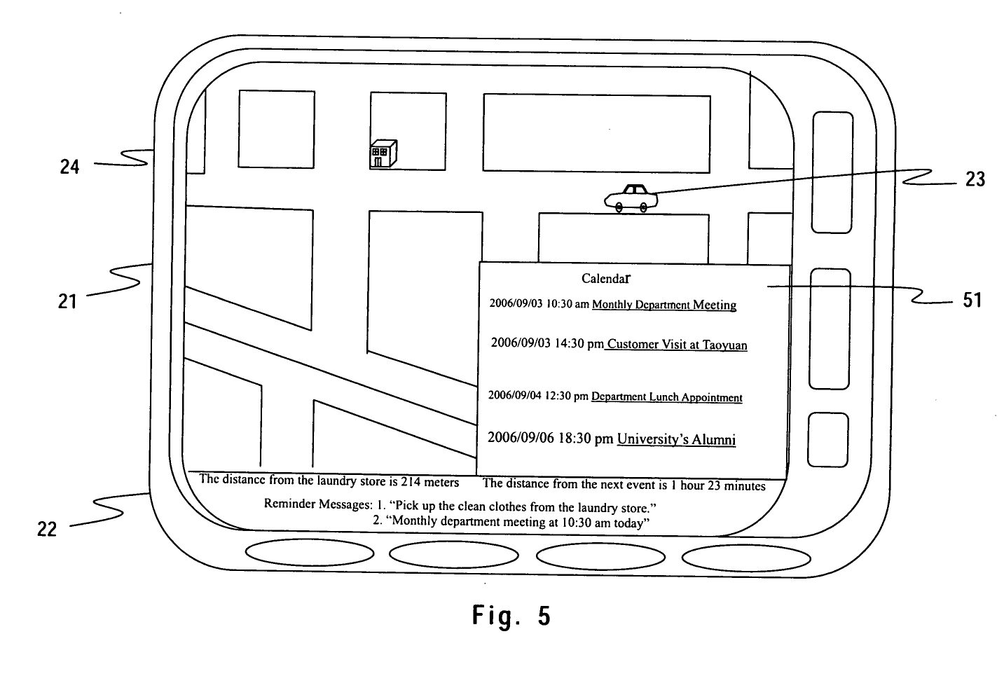

Referring to FIG. 5 for a schematic view of an integration message reminder apparatus of a preferred embodiment of the present invention, the integration message reminder apparatus integrates a regional message reminder system and a time message reminder system. The time message reminder system is a traditional calendar system 51 provided for users to input a plurality of time data and a reminder message corresponding to the time data, which primarily adopts time as the basis of setting the message reminder. The regional message reminder system primarily adopts a region as the basis of setting the message reminder. If a user is driving a vehicle 23, a map showing the driving path of the vehicle 23 will be displayed through a map window 21, and the user can input a plurality of address data, and a reminder message corresponding to the address data in advance. For instance, a user can input an address data of a laundry store 24 and a corresponding reminder message “Pick up the clean clothes from the laundry store”, While the user is driving a vehicle 23 to work, from work or go out, and the vehicle 23 is approaching the laundry store 24 within a predetermined distance, a reminder message will appear on the message window 22 automatically to remind the user to go to the laundry store 24 to pick up the clean clothes, and thus the user can pick up the cloth on the way, and needs not to make a special trip.

Further, the regional message reminder system integrates a time message reminder system for the application, and a user can input an instruction for displaying a reminder message when the user passes through a specific position with a specific time. For instance, it takes about three days for the laundry store to deliver clean clothes after the user has sent the laundry to the store, and the user can set up a reminder message “Pick up the clean clothes from the laundry store” displayed three days later when the user approaches the laundry store. Therefore, such arrangement can provide a more convenient, efficient and useful application of the message reminder.

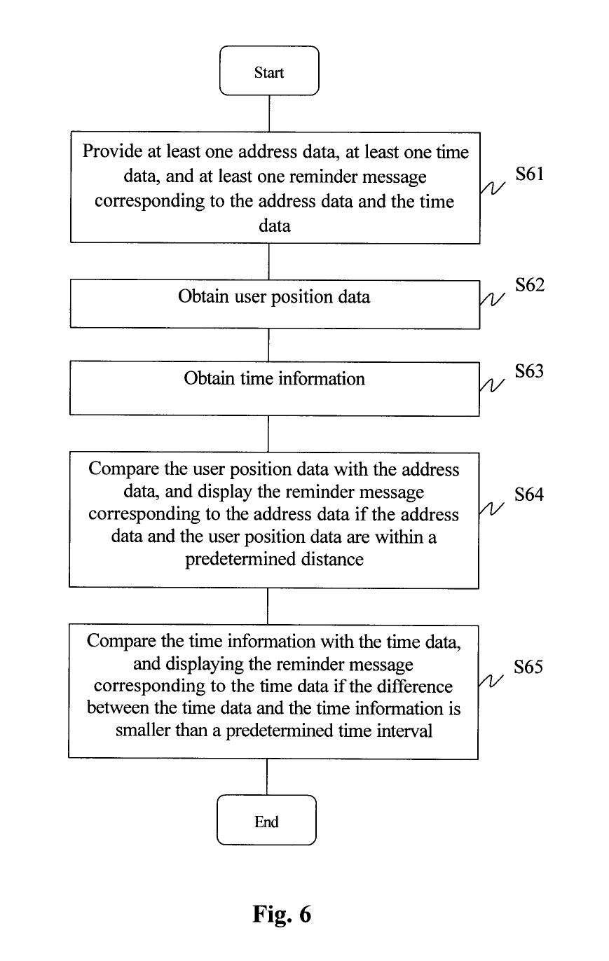

Referring to FIG. 6 for a flow chart of an integration message reminder method of the present invention, the integration message reminder method comprises the following steps. In step S61 at least one address data, at least one time data, and at least one reminder message corresponding to the address data and the time data are provided, for example, the user can input these datum by keying or speaking in advance. In step S62 user position data is obtained. In step S63 time information is obtained. Preferably, the user position data is the current coordinate of the user's location and the time information contains a current date, a current hour and a current minute. And both current coordinate and time information can be obtained from the received satellite signal.

In step S64 the user position data is compared with the address data for determining whether there is any inputted address data near the user. If the address data and the user position data are within a predetermined distance, and the reminder message corresponding to the address data is displayed. In step S65 the time information is compared with the time data. If the difference between the time data and the time information is smaller than a predetermined time interval, the reminder message corresponding to the time data is displayed.

The description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A regional message reminder apparatus, comprising:
a satellite positioning device for providing user position data;
a user interface module provided for allowing a user to input at least one address data and at least one reminder message corresponding to said address data, and for displaying said reminder message;
a database for storing said address data and said reminder message;
a processing module for comparing said user position data with said inputted address data, and driving said user interface module to display said reminder message corresponding to said address data if said address data and said user position data are within a predetermined distance.

2. The regional message reminder apparatus of claim 1, wherein said reminder message includes a text reminder message.

3. The regional message reminder apparatus of claim 1, wherein said reminder message includes a voice reminder message.

4. The regional message reminder apparatus of claim 3, further comprising an amplifier for sending out said voice reminder message.

5. The regional message reminder apparatus of claim 1, wherein said user can select a location with said reminded address data as a destination through said user interface module, and then said processing module calculates a route from said user position to said location and navigates said user to said location based on said route.

6. A regional message reminder method, comprising the steps of:
providing at least one address data and at least one reminder message corresponding to said address data;
obtaining user position data;
comparing said user position data with said address data; and
displaying said reminder message corresponding to said address data if said address data is apart from said address data within a predetermined distance.

7. The regional message reminder method of claim 6, wherein said address data and said reminder message are inputted by a user.

8. The regional message reminder method of claim 6, wherein said reminder message includes a text reminder message.

9. The regional message reminder method of claim 6, wherein said reminder message includes a voice reminder message.

10. The regional message reminder method of claim 9, further comprising a step of sending out said voice reminder message corresponding to the address data which is apart from said address data within a predetermined distance.

11. The regional message reminder method of claim 6, further comprising a step of selecting a location with said address data to be a destination and calculating a route form the user position to said destination for navigation.

12. An integration message reminder apparatus, comprising:
a satellite positioning device for providing user position data;
a user interface module provided for allowing a user to input at least one address data at least one said time data and at least one reminder message corresponding to said address data and said time data, and for displaying;
a database for storing said address data, said time data and said reminder messages;
a timing module for computing time information; and
a processing module, for comparing said user position data with said address data, and comparing said date and time information with said time data, and driving said user interface module to display said reminder message corresponding to said address data or displaying said reminder message corresponding to said time data if said address data and said user position data are within a predetermined distance, or the difference between said time data and said time information is smaller than a predetermined time interval.

13. The integration message reminder apparatus of claim 12, wherein said reminder message includes a text reminder message.

14. The integration message reminder apparatus of claim 12, wherein said reminder message includes a voice reminder message.

15. The integration message reminder apparatus of claim 14, further comprising an amplifier for sending out a voice reminder message.

16. The integration message reminder apparatus of claim 12, wherein said user can select a location with said reminded address data as a destination through said user interface module, and then said processing module calculates a route from said user position to said location and navigates said user to said location based on said route.

17. An integration message reminder method, comprising:
providing at least one address data, at least one time data, and at least one reminder message corresponding to said address data and said time data;
obtaining user position data;
obtaining time information;
comparing said user position data with said address data, and displaying said reminder message corresponding to said address data if said address data and said user position data are within a predetermined distance; and
comparing said time information with said time data, and displaying said reminder message corresponding to said time data if the difference between said time data and said time information is smaller than a predetermined time interval.

18. The integration message reminder method of claim 17, wherein said reminder message includes a text reminder message.

19. The regional message reminder method of claim 17, wherein said address data, said time data and said reminder message are inputted by a user.

20. The regional message reminder method of claim 17, further comprising a step of selecting a location with said address data to be a destination and calculating a route form the user position to said destination for navigation.
